(19) United States
(12) Patent Application Publication
(10) Pub. No.: US 2005/0207043 A1
(43) Pub. Date: Sep. 22, 2005

(54) Automobile side view mirror

(76) Inventor: Huei-Ling Su, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/802,788

(22) Filed: Mar. 18, 2004

(51) Int. Cl. G02B 5/08; G02B 7/182

(52) U.S. Cl. 359/879; 359/871

(57) ABSTRACT

A side view mirror assembly includes a casing inside which a reflector is mounted and a mount by which the casing and reflector are mounted to an automobile. The mount includes an outer frame member defining a triangular opening to receive a stack of first and second inner mount members. The first inner mount member has an outside surface on which two elongated slots are formed to each receive an L-shaped slide. Each L-shaped slides has a first section slidably received in the slot and a second section perpendicular to the first section and fixing an end of a helical spring of which an opposite end is fixed to the casing. The first section of the slide defines an inner-threaded hole. A bolt that extends through a hole defined in the second inner mount member and the slot of the first inner mount member is engageable with the inner-threaded hole of the slide. By tightening the bolt, the spring is elongated and inducing a force that securely retains the casing on the mount. By completely loosening the bolt, the casing is allowed to detach from the mount as an independent unit.

### BACKGROUND OF THE INVENTION

1. Field of the Invention

The present invention generally relates to the field of auto parts and in particular to an automobile side view mirror that allows for replacement of parts damaged without changing a whole set of the side view mirror assembly.

2. The Related Art

An automobile is equipped with a rearview mirror inside the automobile and two side view mirrors on opposite sides of the automobile, which mirrors are provided for driving safety. Theses mirrors allow the driver to watch out any coming vehicles or other obstacles in for example changing lanes and reversing. Thus, maintaining proper function of these mirrors is of vital importance for driving safety. Among these mirrors, the side view mirrors are subject to damages easily due to the fact that they are mounted outside the automobile.

A side view mirror is generally comprised of a mount to which a partially open casing is mounted for housing a reflector or a planar (or convex) mirror. Conventionally, the mount, the casing and the reflector are integrated together as a single unit for convenient replacement thereof in automobile maintenance and/or repairing. In other words, each time any one of these parts, the mount, the casing and the reflector, is damaged, the whole set of the side view mirror assembly must be replaced by a new set. This, although being time efficient in repairing, causes a waste and is against the trend of environmental protection.

Furthermore, automobiles of different brands have different designs of at least some of the parts, including the side view mirrors. This makes it difficult to provide a side view mirror of universal design that is fit for some or most of the automobile modes available in the market. The inventory of parts for garages and/or auto parts manufacturers is thus increased, resulting in inefficiency of parts management and warehousing.

Thus, the present invention is aimed to provide an automobile side view mirror that overcomes the drawbacks of the conventional side view mirrors.

### SUMMARY OF THE INVENTION

Thus, a primary objective of the present invention is to provide an automobile side view mirror assembly comprising a mount, a casing and a reflector that are detachably mounted together whereby when any one of these parts is damaged, the parts can be completely detached from each other to allow for replacement of the damaged one only.

Another objective of the present invention is to provide a universal automobile side view mirror that can be adopted in any model of automobile available in the market.

To achieve the above objectives, in accordance with the present invention, there is provided a side view mirror assembly comprising a casing inside which a reflector is mounted and a mount by which the casing and reflector are mounted to an automobile. The mount comprises an outer frame member defining a triangular opening to receive a stack of first and second inner mount members. The first inner mount member has an outside surface on which two elongated slots are formed to each receive an L-shaped slide. Each L-shaped slides has a first section slidably received in the slot and a second section perpendicular to the first section and fixing an end of a helical spring of which an opposite end is fixed to the casing. The first section of the slide defines an inner-threaded hole. A bolt that extends through a hole defined in the second inner mount member and the slot of the first inner mount member is engageable with the inner-threaded hole of the slide. By tightening the bolt, the spring is elongated and inducing a force that securely retains the casing on the mount. By completely loosening the bolt, the casing is allowed to detach from the mount as an independent unit.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of an automobile side view mirror constructed in accordance with the present invention;

FIG. 2 is an exploded view of the automobile side view mirror of the present invention; and

FIG. 3 is a cross-sectional view of a portion of the automobile side view mirror of the present invention.

### DETAILED DESCRIPTION OF THE PREFERRED EMBODIMENT

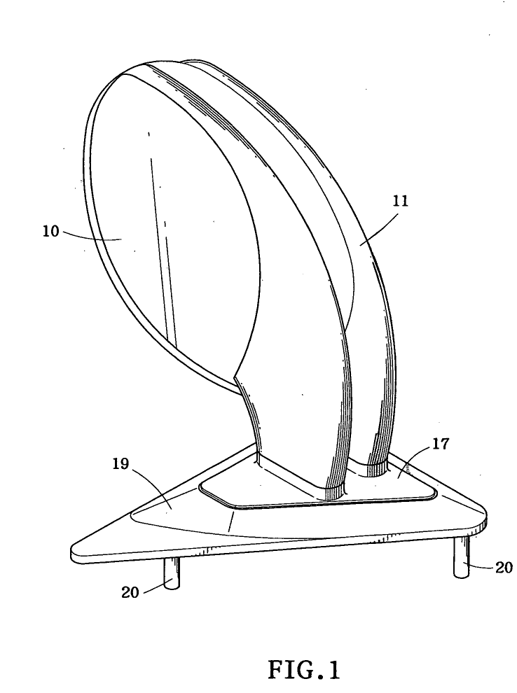

With reference to the drawings and in particular to FIG. 1, an automobile side view mirror constructed in accordance with the present invention comprises a mount to which a partially open casing 11 is detachably mounted and a reflector 10 mounted inside the casing 11 and exposed through the opening of the casing 11. The reflector 10 can be of a planar mirror, a concave mirror or the likes.

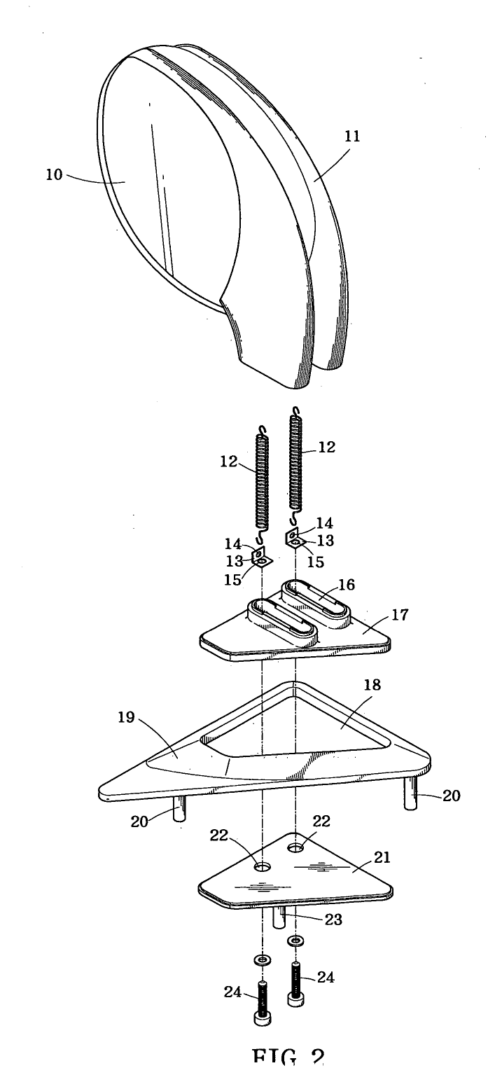

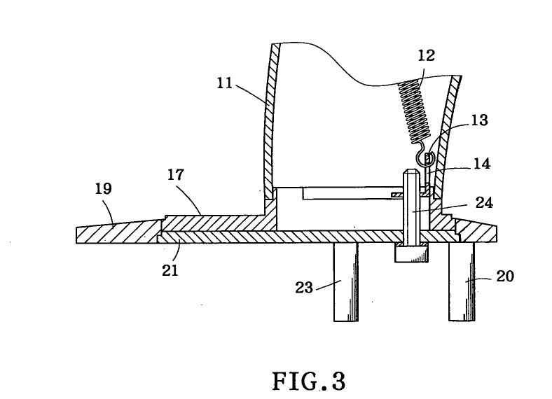

Also referring to FIGS. 2 and 3, the mount is comprised of an outer frame 19 defining a triangular opening 18, a first inner mount member 17 and a second inner mount member 21. The first and second inner mount members 17, 21 are snugly received in the opening 18 of the outer frame 19 and overlap each other. The first inner mount member 17 has an outside surface on which the casing 11 rests and an inside surface contacting and supported by an inside surface of the second inner mount member 21. The second inner mount member 21 has an outside surface in surface contact with an automobile body (not shown) to which the side view mirror of the present invention is mounted.

Two elongated slots 16 are formed on the outside surface of the first inner mount member 17. Each slot 16 movably receives an L-shaped slide 13 therein. The slide 13 has a first section (not labeled) substantially parallel to the outside surface of the first inner mount member 17 and a second section (not labeled) perpendicular to the first section and extending beyond the slot 16. The second section of the slide 13 defines a hole 14 to which an outer end of a resilient member 12, such as a helical spring, is attached. An inner end of the helical spring 12 is fixed inside the casing 11.

In the embodiment illustrated, the slots 16 are defined by a surrounding wall (not labeled) raised from the outside surface of the first inner mount member 17 and each defines a circumferential shoulder (not labeled) to support a projection (not labeled) of the casing 11 that is complementary in size and shape to the slot 16 in order to properly position the casing 11 on the first inner mount member 17.

The second section of each slide 13 defines an inner-threaded hole 15. Two holes 22 are defined in the second inner mount member 21 corresponding in position to the inner-threaded holes 15 of the slides 13. A blot 24 extends through the hole 22 and the slot 16 to engage the inner-threaded hole 15 of each slide 13 with a bolt head (not labeled) abutting against the outside surface of the second inner mounted member 21, preferably with a washer interposed between the second inner mount member 21 and the bolt head.

By tightening the bolts 24, the helical springs 12 are elongated and thus applying a force to the casing 11 to securely retain the casing 11 (and the reflector 10 mounted inside the casing 11) on the first inner mount member 17. To detach the casing 11 from the mount, the bolts 24 are completely loosened and the slides 13 are allowed to separate from the slots 16 and retract into the casing 11 by the spring force of the springs 12. Preferably, a stop (not shown) is formed inside or on the casing 11 to hold the slides 13 at a readily accessible position when the slides 13 are retracted into the casing 11 by the springs 12.

Thus, when the casing 11 and/or the reflector 10 are damaged, the casing 11 can be detached from the mount and replaced by a new one. Further, the resiliency of the springs 12 allows the side view mirror to translate and rotate when the side view mirror is subject to an external impact or collision and to return to its original position after the impact or collision is removed.

The second inner mount member 21 is received within the opening 18 of the outer frame 19 whereby the outside surface of the second inner mount member 21 forms a continuous plane with an inside surface of the outer frame 19, which helps readily mounting the side view mirror assembly of the present invention to the automobile body. To properly position the side view mirror assembly on the automobile body, positioning pins 20 and 23 extend from the inside surface of the outer frame 19 and the outside surface of the second inner mount member 21. These positioning pins 20, 23 are engageable with corresponding holes or slots defined in the automobile body to properly position the side view mirror with respect to automobile body. Any releasable means may be employed to fix the mount of the side view mirror of the present invention to the automobile body to allow for removal of the side view mirror from the automobile body. Alternatively, the mount can be fixedly attached to the automobile body.

Although the present invention has been described with reference to the preferred embodiment thereof, it is apparent to those skilled in the art that a variety of modifications and changes may be made without departing from the scope of the present invention which is intended to be defined by the appended claims.

1. A side view mirror assembly comprising:
a casing inside which a reflector is mounted; and
a mount comprising:
an outer frame member defining an opening,
a first inner mount member received in the opening, the first inner mount member having an outside surface on which an elongated slot is formed,
a second inner mount member also received in the opening,
an L-shaped slide having a first section slidably received in the slot and a second section extending from the first section, the first section defining an inner-threaded hole,
a resilient member having opposite ends attached to the first section of the slide and the casing, and
a bolt extending through a hole defined in the second inner mount member and the slot of the first inner mount member and engaging the inner-threaded hole of the slide thereby securing the casing to the mount, whereby by completely loosening the bolt, the casing is allowed to detach from the mount as an independent unit.

2. The side view mirror assembly as claimed in claim 1, wherein the first inner mount member forms two slots, each receiving a slide, two bolts extending through two holes defined in the second inner mount member to respectively engage the inner-threaded holes of the slides, two resilient members being provided between the casing and the mount, each having ends attached to the casing and each slide.

3. The side view mirror assembly as claimed in claim 1, wherein the resilient member comprises a helical spring.

4. The side view mirror assembly as claimed in claim 1, wherein positioning pins extend from the outer frame and the second inner mount member and adapted to engage holes defined in an automobile body for properly positioning the side view mirror on the automobile body.

5. The side view mirror assembly as claimed in claim 1, wherein the opening defined in the outer frame of the mount is substantially triangular.
